(19) United States
(12) Patent Application Publication
(10) Pub. No.: US 2019/0299955 A1
(43) Pub. Date: Oct. 3, 2019

(54) AUTONOMOUS VEHICLE BRAKE SYSTEM

(71) Applicant: VEONEER US INC., Southfield, MI (US)

(72) Inventor: William Alan Szabela, Brookston, IN (US)

(21) Appl. No.: 15/939,527

(22) Filed: Mar. 29, 2018

(51) Int. Cl. B60T 13/74; B60T 13/68

(52) U.S. Cl. CPC B60T 13/745; B60T 2270/413; B60T 13/686

(57) ABSTRACT

An apparatus comprising a first circuit module and a second circuit module. The first circuit module may be configured to communicate with a vehicle over a first bus. The first circuit module generates one or more first brake control signals in response to one or more command inputs and is powered by a first power source. The first brake control signals provide primary control of hydraulic flow and pressure to control one or more brake calipers in a vehicle. The second circuit module may be configured to communicate with the vehicle over a second bus. The second circuit module generates one or more second brake control signals in response to said one or more command inputs and is powered by a second power source. The second brake control signals provide secondary control of hydraulic flow and pressure to control the one or more brake calipers. The first and the second circuit modules are fabricated on a single printed circuit board to provide redundant control of the one or more brake calipers.

### FIELD OF THE INVENTION

The invention relates to autonomous vehicles generally and, more particularly, to a method and/or apparatus for implementing a braking system for an autonomous vehicle.

### BACKGROUND

Autonomous vehicles need to implement redundancy on many systems. Conventional autonomous vehicle design has focused on vision systems to prevent collisions. Braking systems have received less design attention. Without a driver initiating a physical movement on a brake pedal, an autonomous vehicle uses electronically generated and transmitted control signals. If one of the components that generates or transmits electronic control signals fails, the vehicle needs to be capable of stopping. In an autonomous braking system, back-up systems and/or redundant systems are needed.

It would be desirable to implement an autonomous vehicle brake system that provides redundancy.

### SUMMARY

The invention concerns an apparatus comprising a first circuit module and a second circuit module. The first circuit module may be configured to communicate with a vehicle over a first bus. The first circuit module generates one or more first brake control signals in response to one or more command inputs and is powered by a first power source. The first brake control signals provide primary control of hydraulic flow and pressure to control one or more brake calipers in a vehicle. The second circuit module may be configured to communicate with the vehicle over a second bus. The second circuit module generates one or more second brake control signals in response to said one or more command inputs and is powered by a second power source. The second brake control signals provide secondary control of hydraulic flow and pressure to control the one or more brake calipers in a vehicle. The first and the second circuit modules are fabricated on a single printed circuit board to provide redundant control of the one or more brake calipers.

### BRIEF DESCRIPTION OF THE FIGURES

Embodiments of the invention will be apparent from the following detailed description and the appended claims and drawings in which:

FIG. 1 is a diagram of a context of the control module of invention in a vehicle;

FIG. 2 is a more detailed diagram of the control module;

FIG. 3 is a diagram of a brake topology;

FIG. 4 is a diagram of an alternate topology;

FIG. 5 is a diagram of an alternate topology;

FIG. 6 is a diagram of a more detailed view of the control module; and

FIG. 7 is a diagram of a more detailed view of a hydraulic section.

### DETAILED DESCRIPTION OF THE EMBODIMENTS

Embodiments of the present invention include providing a brake system that may (i) operate in an autonomous vehicle environment, (ii) provide redundant control of vehicle brakes, (iii) implement an electronic control unit having primary and secondary control in a single housing and/or (iv) be cost effective to implement.

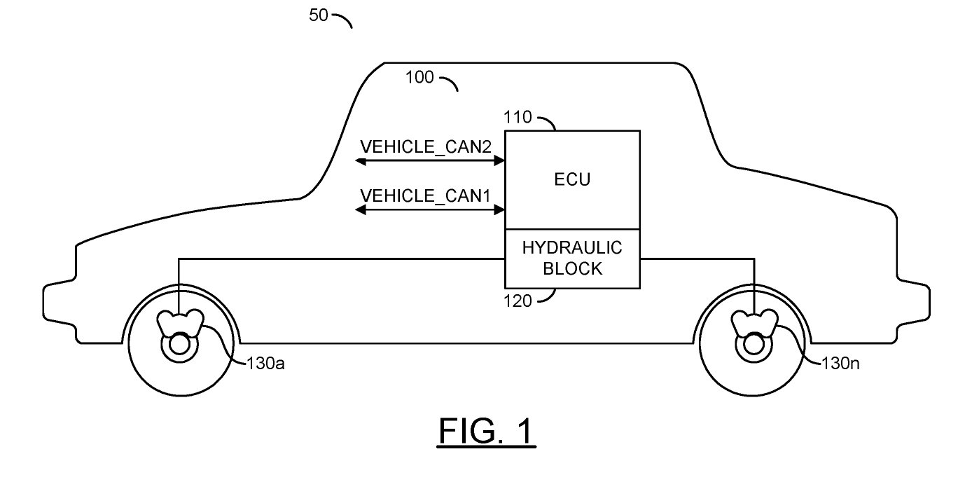

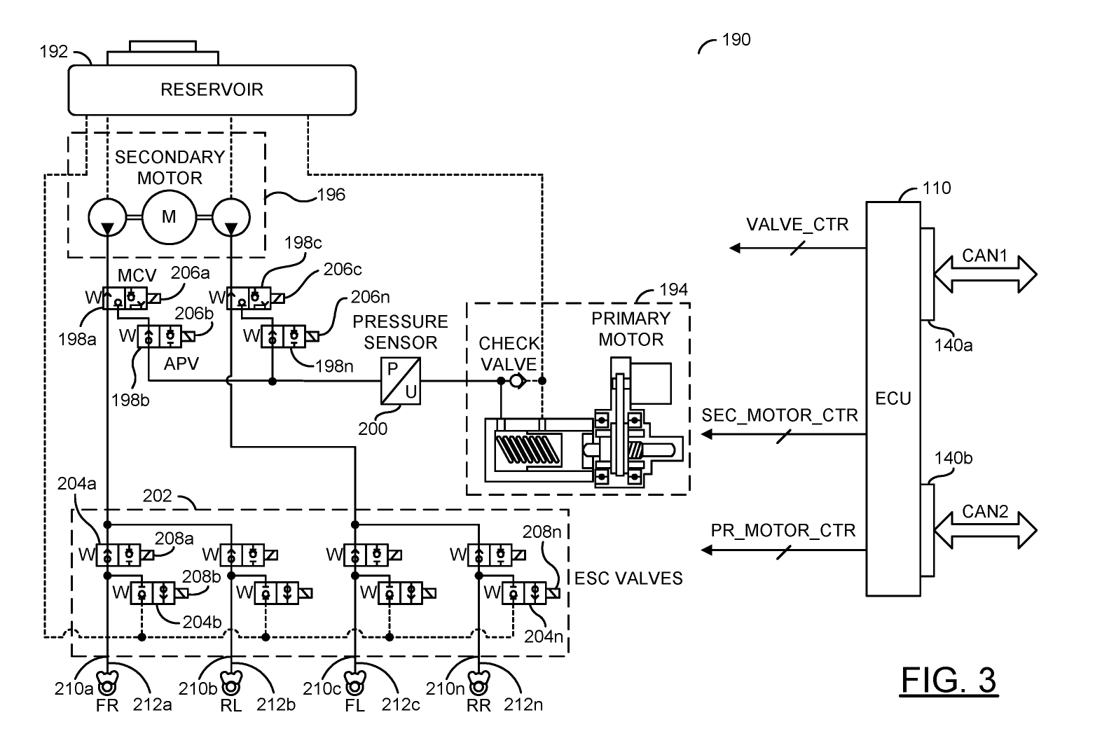

Referring to FIG. 1, a block diagram of a vehicle 50 implementing am apparatus 100 is shown in accordance with an embodiment of the invention. The apparatus 100 may be implemented as a brake control assembly. In an example, the apparatus 100 may be an electronic boosted brake (EBB) system. The assembly 100 generally comprises a section 110 and a section 120. The section 110 may be implemented as an electronic control unit (ECU) section. The section 120 may be implemented as a hydraulic section. The hydraulic section may be implemented as a hydraulic block (or hydraulic control unit (HCU)). The hydraulic section 120 may control one or more brake calipers 130a-130n by controlling hydraulic flow and/or pressure. The apparatus 100 may provide a primary control of the brake calipers 130a-130n through a primary motor (to be described in connection with FIG. 3). The apparatus 100 may also provide a secondary control of the brake calipers 130a-130n through a backup (or secondary) motor (to be described in connection with FIG. 3). The secondary motor may be used to control the brake calipers 130a-130n in a situation where the primary motor loses power and/or otherwise experiences a catastrophic failure. A bus (e.g., CAN1) and a bus (e.g., CAN2) provide separate communication paths to the electronics section (not shown) of the vehicle 50. The apparatus may receive a brake control signal (e.g., BRAKE_CTR) from the bus CAN1 and the bus CAN2.

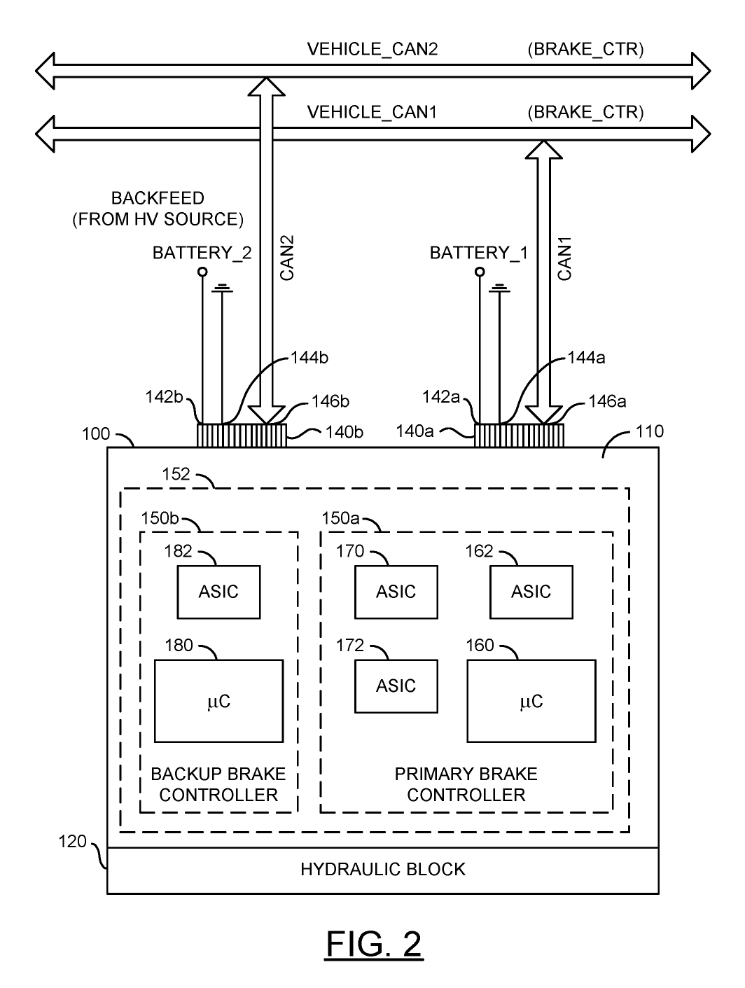

Referring to FIG. 2, a more detailed diagram of the apparatus 100 is shown. The ECU section 110 is shown with a port 140a and a port 140b. The port 140a generally comprises an input 142a, an input 144a, and an input/output 146a. The input 142a may be connected to a power source (e.g., BATTERY_1). The input 144a may be connected to ground. The input/output 146a may be connected to the communication bus CAN1. The port 140b generally comprises an input 142b, an input 144b, and an input/output 146b. The input 142b may be connected to a power source (e.g., BATTERY_2). The input 144b may be connected to ground. The input/output 146b may be connected to the communication bus CAN2. The connection to BATTERY_2 may be a redundant connection to a physical battery. In an example, BATTERY_2 may be a back feed connection to a high voltage bus (e.g., a 44v bus). The input/output 146a may be connected to the bus CAN1. The input/output 146b may be connected to the bus CAN2. One or more command inputs (e.g., the signal BRAKE_CTR) may be received over (i) the bus CAN1 and (ii) the bus CAN2. The command inputs BRAKE_CTR may comprise brake command signals generated by a vehicle logic. The command inputs BRAKE_CTR may be configured to electronically specify an intended level of braking. Separate power (e.g., BATTERY_1 and BATETRY_2) and ground connections are provided for redundancy.

The ECU section 110 generally comprises a controller 150a and a controller 150b. The controller 150a generally comprises a block (or circuit) 160, a block (or circuit) 162, a block (or circuit) 170, and a block (or circuit) 172. The circuit 162 may be implemented as an application specific integrated circuit (ASIC). The circuit 170 may be implemented as an ASIC. In an example, the ASIC may control primary three phase brushless motor. The circuit 172 may be implemented as an ASIC. In an example, the ASIC 172 may implement an electronic stability control (ESC) function. The ASIC 162 may control one or more valves (to be described in more detail in connection with FIG. 3.). The ASIC 170 and/or the ASIC 172 may control one or more valves. The controller 150b generally comprises a block (or circuit) 180, and a block (or circuit) 182. The circuit 180 may be implemented as a microcontroller. The circuit 182 may be implemented as and ASIC. The ASIC 182 may control one or more valves. The ASIC 182 may also control a DC motor.

Referring to FIG. 3, a diagram of a topology 190 is shown. The topology 190 generally comprises the ECU 110, a reservoir 192, a primary motor 194, a secondary motor 196, a number of valves 198a-198n, a block (or circuit) 200, and a section 202. The section 202 generally comprises a number of valves 204a-204n. The section 202 may be an ESC valve section. The valves 198a-198n each have a plunger 206c-206n (or control pin). The valves 204a-204n each have a plunger 208a-208n (or control pin). The section 202 generally has a number of outputs 210a-210n. A number of lines 212a-212n connect to the calipers 130a-130n. The lines 212a-212n may be implemented as hydraulic brake lines (or hydraulic brake pipes).

The ECU circuit 110 is shown generating a signal (e.g., VALVE_CTR), a signal (e.g., PR_MOTOR_CTR) and a signal (e.g., SEC_MOTOR_CTR. The signal PR_MOTOR_CTR may comprise one or more signals configured to control the primary motor 194. The signal SEC_MOTOR_CTR may comprise one or more signals configured to control the backup motor 196. The signal VALVE_CTR may comprise one or more signals configured to control the valves 198a-198n and/or the valves 204a-204n. The valves 204a-204n generally control the calipers 130a-130n.

The primary braking controller 150a (within the block 110) may communicate through the bus CAN1 to provide primary braking control for the vehicle 50. The primary brake controller 150a may provide primary performance features by controlling the calipers 130a-130n through the primary motor 194. In the example of FIG. 3, the primary motor 194 may be implemented as a hydraulic motor. The backup brake controller 150b provides secondary braking control. The backup brake controller 150b may be used to power and/or control the backup motor 196. The backup motor 196 may be implemented as a DC brush motor/pump unit. The motor/pump unit 196 may provide hydraulic pressure/force to the brake calipers 160a-130n in a situation where the primary brake controller 150a unit loses power or experiences a catastrophic failure.

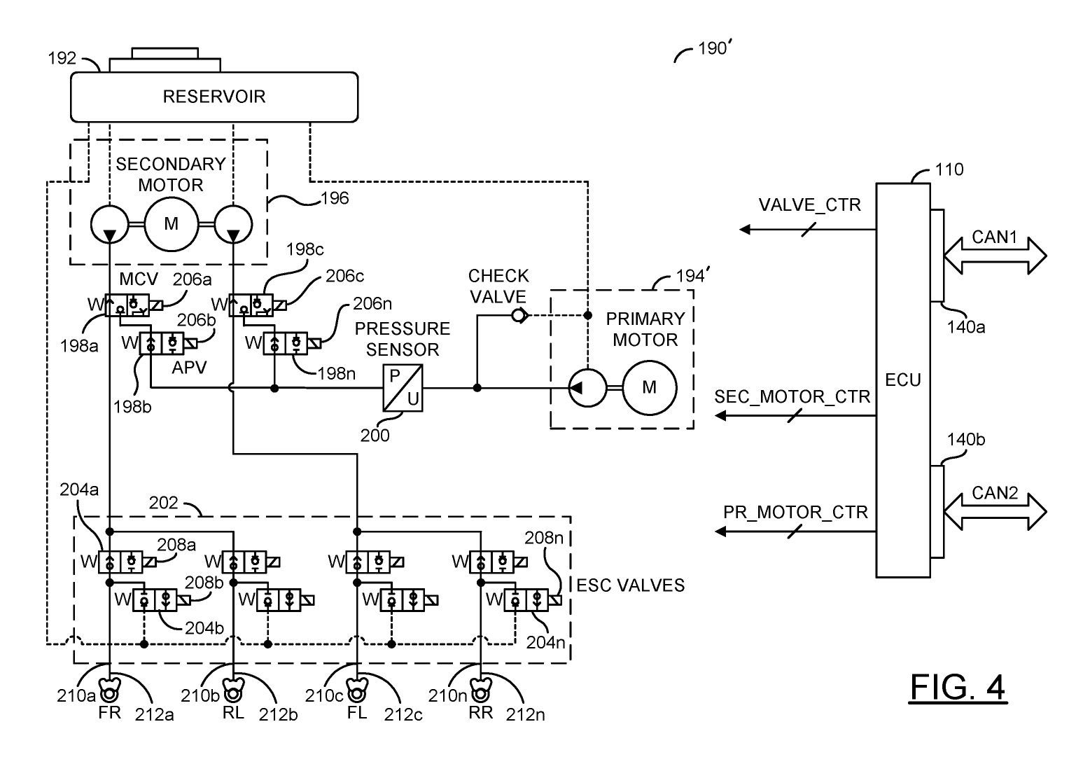

Referring to FIG. 4, a diagram of a topology 190′ is shown. The topology 190′ is shown implementing the primary motor 194′ as an electric motor.

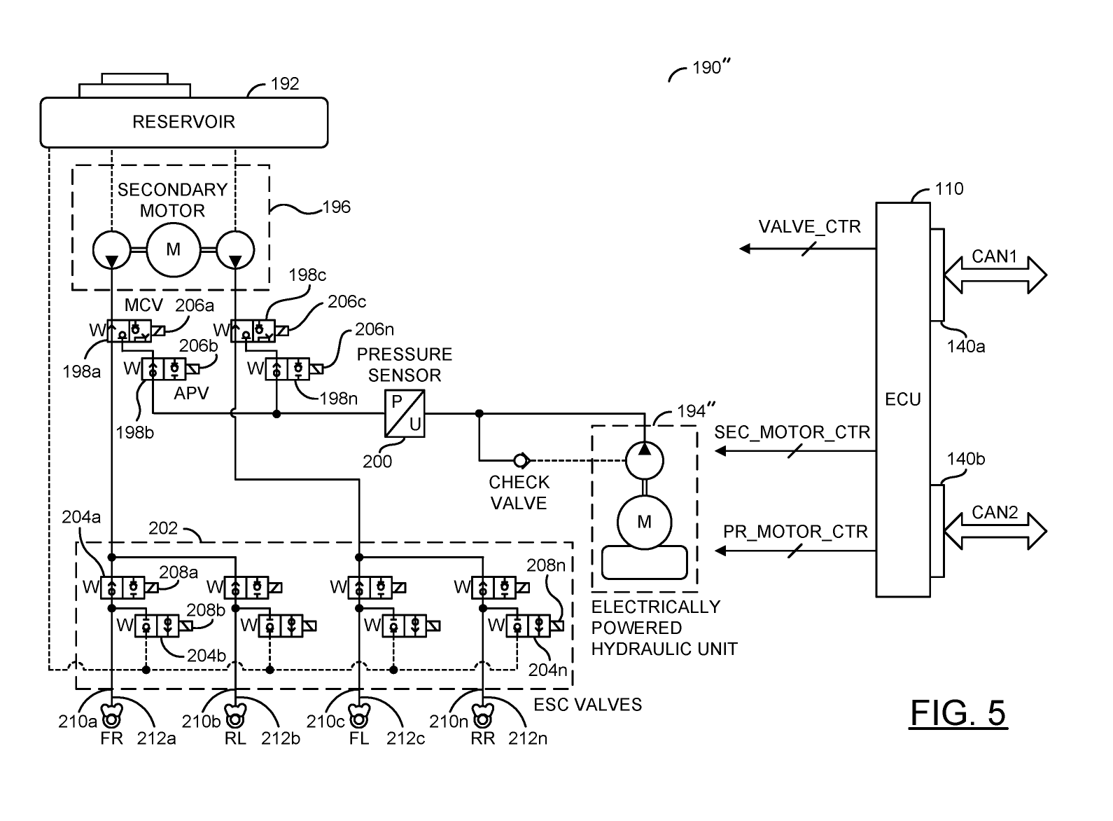

Referring to FIG. 5, a diagram of a topology 190″ is shown. The topology 190″ is shown implementing the primary motor 194″ as an electrically powered hydraulic unit.

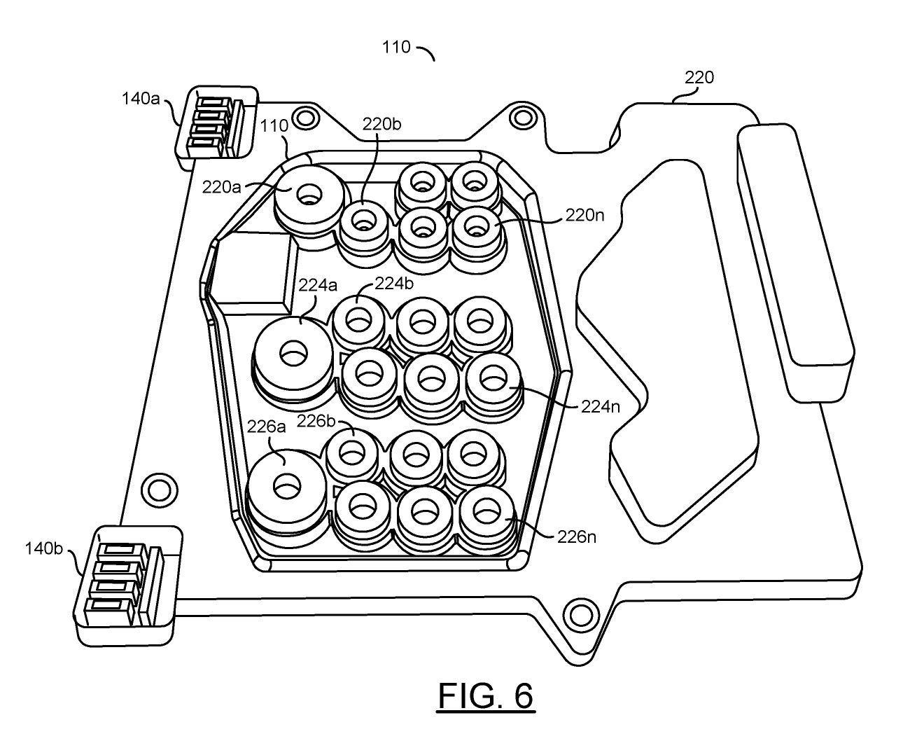

Referring to FIG. 6, a diagram illustrating a more detailed view of the module 110 is shown. The module 110 is shown connected to a housing 220. The port 140a and the port 140b are shown as electrical harnesses. The port 140a may be connected to the bus CAN1. Additional connections (not shown) may also be electrically connected to the port 140a. In an example, a connection to a wheel speed sensor may be directly connected to the port 140a. Other direct connections may also me implemented to meet the design criterial of a particular implementation. The port 140b may have similar connections to provide redundancy.

The module 110 is shown with a plurality of coils 222a-222n, a plurality of coils 224a-224n, and a plurality of coils 226a-226n. The coils 222a-222n may be connected to the ASIC circuit 162. The coils 222a-222n may control the valves 206a-206n. The coils 224a-224n may be connected to the ASIC circuit 170. The coils 224a-224n may control the valves. The coils 226a-226n may be connected to the ASIC circuit 172. The coils 226a-226n may control the valves 204a-204n. The particular ASIC circuit 160, 162 and/or 164 used to control the particular valves 204a-204n and/or 206a-206n may be varied to meet the design criteria of a particular implementation.

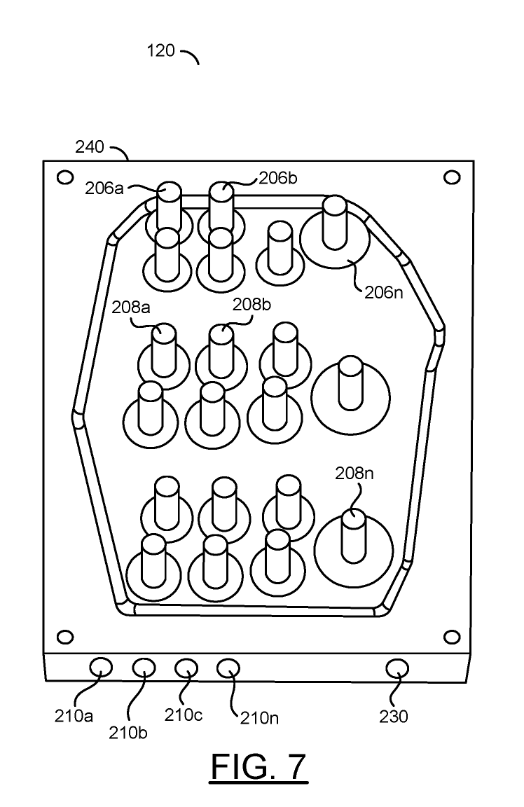

Referring to FIG. 7, a more detailed diagram of the hydraulic block 120 is shown. The hydraulic block is shown including a casing 240 and a plurality of pins 206a-206n and a plurality of pins 208a-208n. The pins 206a-206n may be configured to physically interconnect with the coils 220a-220n. A first group of the pins 208a-208n may be configured to physically interconnect with the coils 224a-224n. A second group of the pins 208a-208n may be configured to physically interconnect with the coils 226a-226n. The various coils 222a-222n, 224a-224n, and/or 226a-226n control the operation of the various valves 206a-206n and/or 208a-208n. The control generally responds to the signal VALVE_CTR generated by the controller 110. One or more of the pins 206a-206n may be controlled by the pressure sensor 200.

Each of the valves 198a-198n may include a valve body and a respective pin (or plunger) 206a-206n. Each of the valves 204a-204n may include a valve body and a respective plunger 208a-208n. The are valves 198a-198n and/or 204a-204n may be implemented as hydraulic valves. The plungers 206a-206n and/or 208a-208n may open or close depending on the state of the coils 220a-220n and/or 224a-224n. When one of the coils 220a-220n and/or 224a-224n energizes (or actuates), a respective plunger 206a-206n and/or 208a-208n either closes a path to stop oil from flowing, or opens a path for oil to flow. Various types of hydraulic valves may be implemented to meet the design criteria of a particular implementation. The valves 198a-198n and/or 204a-204n generally have an inlet and outlet. In an example, a 3-way valve may be implemented.

The coils 220a-220n and/or 224a-224n may have a 2-pin connection to receive the signals VALVE_CTR, PR-MOTOR_CTR and/or SEC_MOTOR_CTR from the ECU circuit 110. The pins provide an electrical connection to the PCB 152. The coils 220a-220n and/or 224a-224n may be connected to the PCB 152 using pressfit technique. The coils 220a-220n and/or 224a-224n physically surround the respective plungers 206a-206n and/or 208a-208n. The plungers 206a-206n and/or 208a-208n physically move inside the respective valve body. When one of the coils 220a-220n and/or 224a-224n is energized, a magnetic field moves a respective one of the plungers 206a-206n and/or 208a-208n.

Autonomous vehicle braking systems may use an electronic boosted brake (EBB) controller with an integrated backup brake DC brush motor/pump unit. A single hydraulic block contains all the necessary control valves, pressure sensors, and check valves. A single package housing two independent electronic control units (ECU) mounts to the hydraulic block. Separate power and ground feeds for the two ECUs as well as two CAN communication busses are provided for redundancy.

In an example, the ECU circuit 110 and the hydraulic block 120 may be manufactured separately. The ECU circuit 110 may be sold as a standalone product. In an example, the ECU circuit 110 may be assembled with the hydraulic block 120 and then installed into the vehicle 50. The brake lines 210a-210n are normally connected to the ports 210a-210n of the hydraulic block 120. A port 130 may receive hydraulic fluid from the reservoir 192. In an example implementation, various installation procedures may be performed. One procedure may be to remove air from the system (e.g., and evacuation (EVAC) procedure). The EVAC procedure may remove air bubbles from the brake lines 210a-210n. A calibration procedure may also be implemented. Various calibration procedures and/or other procedures specific to autonomous vehicles may be implemented.

In an autonomous vehicle environment, brake control signals are generally communicated over the bus CAN1 and/or the bus CAN2. In an autonomous vehicle environment, brake commands are not transmitted with a pedal. Instead of a traditional brake pedal, one or more electronic brake command signals BRAKE_CTR are received over the bus CAN1 and/or the bus CAN2. The signal BRAKE_CTR may electronically specify an intended level of braking. The bus CAN1 and/or the bus CAN2 may receive redundant brake command signals to provide additional reliability.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a first circuit module configured to communicate with a vehicle over a first bus, wherein said first circuit module (i) generates one or more first brake control signals in response to one or more command inputs, (ii) is powered by a first power source and (iii) said first brake control signals provide primary control of hydraulic flow and pressure to control one or more brake calipers in a vehicle; and
a second circuit module configured to communicate with said vehicle over a second bus, wherein (A) said second circuit module (i) generates one or more second brake control signals in response to said one or more command inputs, (ii) is powered by a second power source and (iii) said second brake control signals provide secondary control of hydraulic flow and pressure to control said one or more brake calipers, and (B) said first and said second circuit modules are fabricated on a single printed circuit board to provide redundant control of said one or more brake calipers.

2. The apparatus according to claim 1, wherein said command inputs (i) comprise brake command signals generated by a vehicle logic and (ii) are configured to electronically specify an intended level of braking.

3. The apparatus according to claim 2, wherein said command inputs are received over (i) said first bus and (ii) said second bus.

4. The apparatus according to claim 1, wherein said first and second brake control signals are connected to a hydraulic block to control actuation of one or more brake calipers through hydraulic brake lines.

5. The apparatus according to claim 4, wherein said first and second brake control signals control said actuation of said hydraulic brake lines by actuating one or more valves.

6. The apparatus according to claim 4, wherein said hydraulic brake lines control the operation of said one or more brake calipers on said vehicle.

7. The apparatus according to claim 4, wherein said brake signals are electrically connected to said hydraulic block through one or more press pin connections.

8. The apparatus according to claim 1, wherein said apparatus is implemented in an autonomous vehicle.

9. The apparatus according to claim 1, wherein said first circuit module and said second circuit module provide control of said hydraulic flow and pressure for said brake calipers using a single hydraulic block.

10. The apparatus according to claim 9, wherein said hydraulic flow and pressure is controlled by a primary motor and a secondary motor.

11. The apparatus according to claim 1, wherein said first circuit module is further configured to control an electric park brake operation.
